(19) United States
(12) Patent Application Publication
(10) Pub. No.: US 2010/0124965 A1
(43) Pub. Date: May 20, 2010

(54) PLAYING A VIDEO SLOT GAME

(76) Inventor: Bradley W. Johnson, Henderson, NV (US)

Correspondence Address: MOLLBORN PATENTS, INC., 2840 COLBY DRIVE, BOULDER, CO, 80305, US

(21) Appl. No.: 12/621,145

(22) Filed: Nov. 18, 2009

Related U.S. Application Data
(60) Provisional application No. 61/199,583, filed on Nov. 19, 2008.

(51) Int. Cl. A63F 13/10; A63F 9/24

(52) U.S. Cl. 463/16; 463/25; 463/29; 463/27; 463/37

(57) ABSTRACT

Methods and apparatus, including computer program products, implementing and using techniques for playing a video casino game on a gaming device. A gaming device for a video casino game is provided. A wager is received. The wager indicates an initial number of credits to be played in the video casino game. A total number of credits played on the gaming device is tracked. A random number generator selects a number within a range of numbers. When the total number of credits played by the player is equal to or exceeds the selected number, a new video casino game is presented to the player. The tracking, selecting and presenting steps are repeated until an ending criterion has been reached, such as the player ceasing to play the video casino game, or the player having played a predetermined number of video casino games. A video gaming device is also described.

### CROSS-REFERENCE TO RELATED APPLICATIONS

This application claims priority to U.S. Provisional Application No. 61/199,583, filed on Nov. 19, 2008 and titled “A New Gaming Concept for Video Slot Machines,” the entire content of which is incorporated herein by reference.

### BACKGROUND

The various embodiments described herein relate to casino games. Casinos throughout the U.S. and the world have video and mechanical spinning reel gaming machines on their floors. Most of these spinning reel games operate very similar in that the player makes a wager, the reels spin, and then the reels come to stop under one or more paylines. If the reel symbol combinations under the payline match the reel symbol combinations shown on a paytable, the player wins credits. Generally, the monetary amount the player wins is based upon how much the player bet and how high the symbol combination is ranked on the paytable.

Slot players usually walk around the casino floor looking for games that catch their interest by appearance, or they find games they have successfully played before. If a player plays a game that entertains him/her or if the player wins a lot of money on the game, the player will generally keep playing the game. If not, the player will typically leave the gaming machine and find a different gaming machine.

Modern spinning reel games have incorporated many new features to entertain and keep the player's interest, such as multiple rows and columns of reels, multiple paylines, different denominations such as penny games, and a variety of entertaining features, such as wild symbols, scatter symbols, free games, secondary bonus games, progressive prizes, mystery awards, and numerous others game features. However, current games are still similar to older games, in that the average payout to the player is approximately the same. Generally, each slot machine game has a specific theme, a set number of reel symbols, a set number of audio clips, a set number of game animations and a set number of fun features.

One problem casinos and players are facing is that after a player plays a specific slot machine for a while, and after the player has seen the reels spin many times, over many games, and the player has seen all the features of the game, the player becomes bored with the game. Furthermore, if the player does not win any big awards on the game, the player will finally lose interest and leave the gaming machine, either to find a new gaming machine to play or maybe to leave the casino floor to do something else.

Some existing video slot machines have several games are stored on a hard drive (known as a multi-game machines) and the player can choose a game they want to play, using a menu on the gaming machine. If the chosen game does not pay off or does not entertain enough, the player can change to a new game by going back to the menu. Changing from game to game may, however, cause a player to spend a lot of money without ever finding a game that entertains him or that has bonus games or jackpots that excites the player.

### SUMMARY

The various embodiments described herein provide methods and apparatus for increasing the interest, entertainment for a player using a gaming machine. Furthermore, paytables are provided that provide increased yield to the player, the longer the player remains at the gaming machine. This is accomplished, at least in part, by encouraging the player to transition between various phases, as will be described in further detail below.

In general, in one aspect, methods and apparatus, including computer program products, implementing and using techniques for playing a video casino game on a gaming device are provided. A gaming device operable to display a video casino game to a player is provided. A wager is received from the player. The wager indicates an initial number of credits to be played in the video casino game. A total number of credits played by the player on the gaming device is tracked. A random number generator selects a number within an established range of numbers. In response to detecting that the total number of credits played by the player is equal to or exceeds the selected number, a new video casino game is presented to the player. The tracking, selecting and presenting steps are repeated until an ending criterion has been reached. The ending criterion includes one of: the player ceasing playing the video casino game, and the player having played a predetermined number of video casino games.

Various implementations can include one or more of the following features. The new game can be downloaded to the gaming device from a central game server that contains a library of games. The new game can have a different theme, different reel symbols, different animations and graphics, different game sounds, or different game features, compared to the game being played. The first game can be started over after the player has played the predetermined number of video casino games. A bonus game can be presented to the player, in which bonus game no wager is required and in which the player is guaranteed to win bonus credits. Each new game can have a higher hold percentage and the top award for the new game can be larger than the top award for the current game.

The video casino game can be a video spinning reel game, a video poker game, a video keno game, or a video blackjack game. The new game can be of a similar type to the current game. The gaming device can be a gaming device operable to play the game over the Internet, a gaming device operable to play the game through a home video game network, or a handheld device. An advertisement can be displayed to the player prior to allowing the player to play the new game. Each game can have a progressive jackpot that is unique to the particular game being played. The player can be presented with an option to continue playing the current game or to proceed to the new game. The player can be presented with a menu of games from which the player can make a selection of a game to be played as the new game. The player's playing habits and game results can be analyzed and if a significant change in playing habits or game results is detected, the player can be presented with the new game. A ticket can be issued to the player, which ticket can be redeemed at a later time by the same or a similar gaming device to resume the video casino game at the point where the ticket was issued.

In general, in another aspect, a gaming device is provided. The gaming device has a housing, a display unit, a wager input device, an input control panel, and a control unit. The display unit displays a video casino game. The wager input device receives a wager from a player of the video casino game. The input control panel receives input from the player for playing the video casino game. The control unit converts a received wager into an initial number of credits to be played in the video casino game; tracks a total number of credits played by the player on the gaming device; selects, by a random number generator, a number within an established range of numbers; in response to detecting that the total number of credits played by the player is equal to or exceeds the selected number, causes the display unit to display a new video casino game to the player; and repeats the tracking, selecting and presenting steps until an ending criterion has been reached, the ending criterion including one of: the player ceasing playing the video casino game, and the player having played a predetermined number of video casino games.

Various implementations can include one or more of the following features. The gaming device can be a video spinning reel machine and the input control panel can be a touch sensitive area on the display unit, or one or more physical buttons on a panel of the video spinning reel machine. The control unit can also download the new game to the gaming device from a central game server that contains a library of games. The control unit can also present a bonus game on the display unit, in which bonus game no wager is required and in which bonus game the player is guaranteed to win bonus credits. The control unit can cause the display unit to present the player with a menu of games from which the player can make a selection of a game to be played as the new game.

Various implementations can include one or more of the following advantages. Before a player gets bored with the game he or she is currently playing, the game changes from one phase to a next phase, which means the player gets a completely new game, with a new theme, new sounds, new reel symbols, new game features, and larger top awards, etc. In some embodiments, the player gets a bonus or bonus game upfront if he proceeds to the next phase and/or if he proceeds through all the phases. As a result, the player typically stays at the gaming machine for a longer time period. The player may be encouraged to play faster or to play more credits per bet. The longer the player stays at the game, the better games will be offered to the player with a better payout percentage.

The details of one or more embodiments are set forth in the accompanying drawings and the description below. Other features and advantages will be apparent from the description and drawings, and from the claims.

### DESCRIPTION OF DRAWINGS

FIG. 1 shows a flowchart of a method for using one embodiment.

FIG. 2 shows the two LCD displays on a gaming machine in phase 1, in accordance with one embodiment.

FIG. 3 shows the two LCD displays on a gaming machine when concluding phase 1, in accordance with one embodiment.

FIG. 4 shows the two LCD displays on a gaming machine prior to starting phase 2, in accordance with one embodiment.

FIG. 5 shows the two LCD displays on a gaming machine when concluding phase 2, in accordance with one embodiment.

FIG. 6 shows the two LCD displays on a gaming machine prior to starting phase 3, in accordance with one embodiment.

FIG. 7 shows the two LCD displays on a gaming machine when concluding phase 3, in accordance with one embodiment.

FIG. 8 shows the two LCD displays on a gaming machine prior to starting the last phase, in accordance with one embodiment.

FIG. 9 is a table that shows an exemplary hold percentage and a top jackpot amount for each phase, in accordance with one embodiment.

FIG. 10 is a table that shows ranges of credit played before a player can move to a next phase, in accordance with one embodiment.

Like reference symbols in the various drawings indicate like elements.

### DETAILED DESCRIPTION

### Overview

Generally, the various embodiments described herein relate to improvements to video games played in casinos. In particular, the various embodiments allow players to play conventional video spinning reel games and then, based on one or more predetermined criteria, transition from one phase to a next phase. The player is rewarded for getting to each subsequent phase by getting more entertaining game features along with larger top awards. As a result, players are less likely to get bored while sitting at a video slot game, and are thus likely to play the game for a longer time.

In general, the player plays the game and after a certain period of time the game changes to a completely new game. As will be described below, this is referred to herein as the game transitioning from one phase to another phase. The new game can offer a new game name, new animations, new sounds, new game features and a new paytable, for example. Generally, the paytable makes the new game more attractive than the previous game, for example, by offering larger jackpots, or increased chances for the player to win money. The game continues to transition to new phases until the player reaches the final phase. In some embodiments, the player may get bonus credits or get to play a bonus game to play between different phases and/or after he has played all phases.

Some embodiments offer progressive jackpots or other large jackpots. Typically, those jackpots only reside in the particular phase in which they are offered. Thus, in these embodiments, a gaming machine player can only win certain top awards if he continues to play at the gaming machine until he reaches a certain phase. Further details of how this is accomplished will be described below.

It should be noted that the concept of “phases,” which is used herein is different from the concept of “levels” that is used in many conventional games. A game that employs “Levels” typically allows a player to move from one level to the next by achieving a predetermined, known goal within the particular level, such as a reaching certain number of points or credits, or playing for a certain time, etc., that moves the player to a higher, typically more difficult, level. A phase, in contrast, is a stage in a process of change. Thus, the player does is not required to have any knowledge of the requirements for moving from one phase to the next. The player only knows that if he keeps playing, he is guaranteed at some point to move to the next phase. Furthermore, in games that use “levels,” all the levels are typically under the umbrella of an overall “game theme.” Here, in contrast, a phase is completely unrelated to the previous or next phase in that each phase is an entirely different game, which may or may not be of a similar type, with an entirely different paytable. The player moves from one phase to the next without any knowledge of the underlying requirements needed to move to the next phase, and only the credits collected thus far by the player carries over from one phase to the next. No other information is transferred between phases.

As will be seen below, in some embodiments the player will know exactly what it takes to transfer from one phase to the next. There are also embodiments in which there are specific criteria for transferring from one phase to the next, but these criteria are hidden from the player, and are determined based on a predetermined “strategic plan” for the various phases. Some embodiments may track the player's playing habits and based on this information set criteria for when the transition to a subsequent phase should occur and what game should be played in that phase. For example, if a player bets low, the player may be offered games with incentives to bet more per play; if a player bets slow, the player may be offered games that are faster to play; if the player has had a few big wins, the player may stay longer in that particular phase; if the player has had many losses and no big wins, the new games may be offered faster, etc. As the skilled reader realizes, the variations are essentially endless and a large number of customized decisions may be implemented.

Various embodiments will be described below by way of example with reference to a use scenario in which a player uses a gaming machine to play a game in accordance with one embodiment. However, it should be realized that the embodiments set forth in the examples below are not a complete list and that many variations are possible within the scope of the claims. Before proceeding with the use scenario, a number of definitions will be presented, which will facilitate the reading of the remainder of the specification.

### DEFINITIONS

Hold Percentage—Each gaming machine game has a designated percentage that the player can expect to win back from his bets, with the remaining percentage being won by the casino. These percentages, however, are based on thousands if not millions of plays so on any given game, the player could win much more than he bet or he could lose some or all of his bet. The percentages are calculated by looking at every winning and losing occurrence that can happen on the game and how often each occurs. For all winning symbol combinations, a certain amount is paid to the player based on how much he bet. This payback is figured into hold percentage. The casino has an advantage over the player in almost every game to guarantee over the long term that the casino significantly wins more money than the player. Most video spinning gaming machines have a hold percentage for the player of about 85% to 94%. The casino earns the remaining percentage. For example, if the player bets $100, he can expect to win $85 of it back and the casino to keep the other $15 over the long term.

Game—A complete video slot game is when the player makes a wager on a game, the game is played to conclusion, and the player is asked to make another wager.

Top Award—Almost every game on a video gaming machine has one award that is bigger than any other award offered at the game. The top award is the one that most players would like to win. For example, to most players a game that offers a top award of $500 is not as interesting as a game that offers a top award of $10,000.

Video Spinning Reel Game—Casinos currently offer two types of spinning reel games. One kind is mechanical spinning reel games where the reels are actual reels that physically spin. The other kind is video spinning reel games where there are no physical reels but instead animations of reels.

Server-Based or Downloadable Gaming—The casino industry is currently in the early stages of converting to one or more central systems, where each central system typically controls all the gaming machines on a casino floor. The player will be at a gaming machine, just like before, and either a game is downloaded to the gaming machine and played there by the player, or the player plays a game that resides at the server (i.e., a server-based game). The casino can control which games are available at each gaming machine, or offer the player one or more menus, from which the player can select any game residing in the casino's library of games.

Phases—Many types of home video games have the player gaining points trying to move to the next level. In contrast, the embodiments described herein use phases on gaming machines found in casinos or in games played on the Internet. In brief, the term “phase,” which has been described in detail above, refers to the player reaching (a known or unknown) criteria in the game and advancing to a different game. As the player changes to the new game, his chances of winning larger amounts of money typically improve. Each game occurs at its own different phase. Unlike games that use levels, moving to a new phase does not necessarily mean that the games get increasingly difficult or makes it more difficult for the player to reach the next phase.

Criteria—There many different types of criteria that can be used for the player to reach the next phase. Some examples include the number of games played, the number of credits won or lost, the number of games won or lost, etc. The decision to move the player to a new phase, or the number of credits played per game, can also be random. The player may be required to get a certain symbol, or a certain combination of symbols, on the reels to advance to a new phase. These criteria may or may not be hidden from the player.

Paytable—All reel symbol combinations that win credits are shown on a paytable that the player can examine to verify why he won and how much he should win. Typically, the amount the player wins is proportional to the player's bet. For example, if the player hits Cherries on each reel under the payline, he may win 20 credits with one credit bet. If the initial bet was 50 credits, the player will instead win 1,000 credits.

Credits—In U.S. casinos, players typically deposit money into the gaming machines. The money is then converted into credits. For example, if a player deposits a dollar into a nickel gaming machine, the player will get 20 credits to be used in the gaming machine.

### Use Example

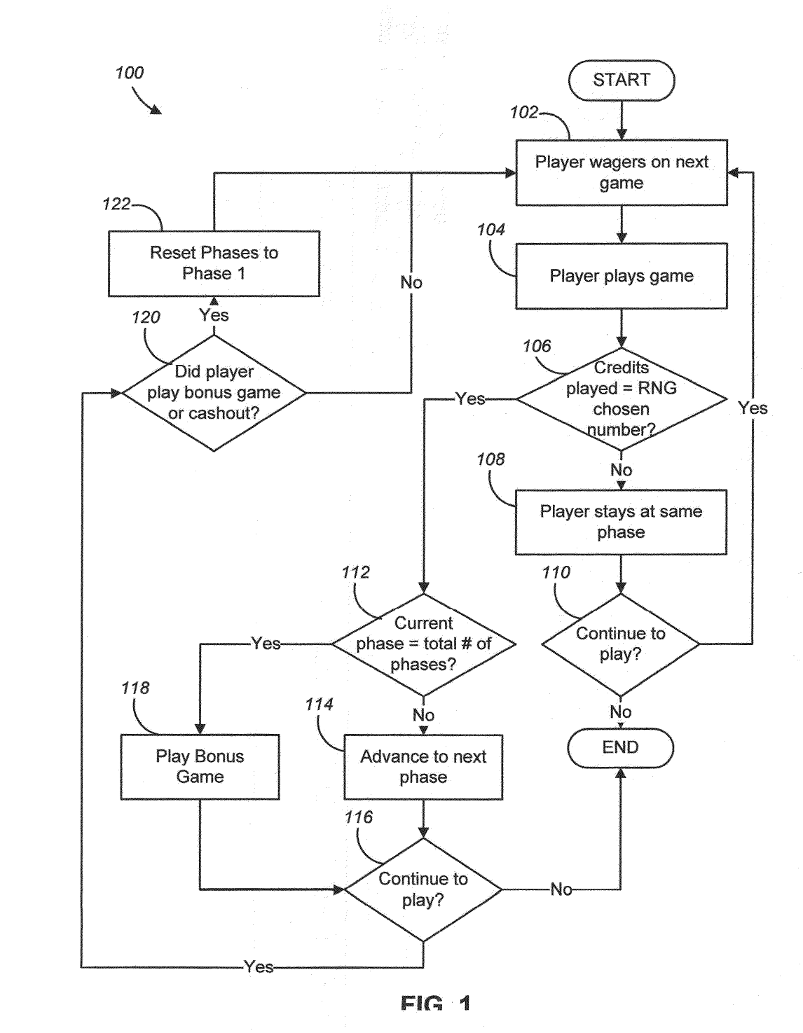

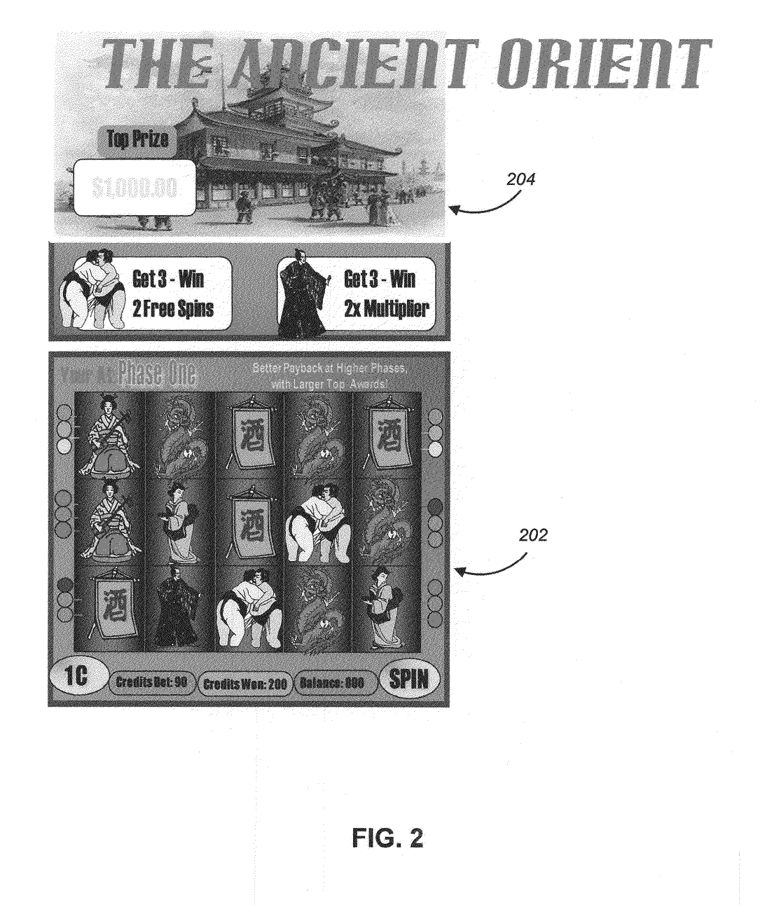

In order to provide a better understanding of the overall operation of the various embodiments, a use example will now be described with reference to the figures. FIG. 1 shows a process (100) for of a use scenario, in accordance with one embodiment, and FIGS. 2-10 show various details of a screens displayed on the gaming machine, in accordance with an embodiment. It should be noted that of course there are many alternative uses to the one that is described below.

A player walks into a casino and wants to play a video slot game. The player locates a video gaming machine that contains a game that uses phases. The gaming machine typically has a main cabinet with a touch screen LCD (Liquid Crystal Display), and a top box with a second LCD. In addition, the gaming machine may also have a player panel that includes a set of buttons similar to those found on most slot machines. The player deposits money into the bill acceptor on the gaming machine (step 102). The money is converted into credits so the player can play the game.

The player plays the game (step 104) by determining the amount of credits he wants to bet on each payline and the number of paylines he would like to play. As the skilled reader realizes, with other types of gaming machines, there may be different betting configurations. Once the player has made all his selections, he pushes a Spin button, which causes all the reels to spin and then come to a stop. The symbol combinations that fall under active paylines and are on the paytable pay credits to the player. If no winning symbol combinations fall under the active paylines, the player loses the credits he bet. For the purposes of this example, it is assumed that the player continues to play more games.

While the player is playing the game, the game software on the gaming machine or the server (if the gaming machine is connected to a central server) tracks the total number of credits played by the player. The game software examines whether the total number of credits played by the player at the gaming machine meets a designated total (step 106). The designated total for each phase can be randomly chosen by the game software, for example, using a random number generator (RNG). In some embodiments, the RNG selects a number from a range that is based on an intended average. A different range may be used for each phase. If the total number of credits played does not meet the designated total, the player stays at the same phase (step 108). It is determined whether the player wants to continue to play (step 110). If the player continues to play, the process returns to step 102 and continues as outlined above. If the player does not want to continue to play, the process ends. As will be seen below, in some embodiments, the player can get presented with the option to proceed to the next phase or to stay in the current phase. If the player decides to stay in the current phase, the criteria for transitioning to the next phase are reset and the player will be presented with the option to proceed at a later time, when the criteria have been fulfilled.

If it is determined in step 106 that the total number of credits played by the player at the gaming machine meets the designated total, the player is authorized to move to the next phase. The player will not know why he is moving from his current game to another game. In some embodiments, the new game is marketed so that player feels as if he made some kind of accomplishment. Prior to moving the player to the next phase, the game software examines whether the player has reached the last phase (step 112).

If the player has not reached the last phase, the game screen shows a “celebration type message” to inform the player that he has been authorized to proceed to the next phase and a new game is downloaded to the gaming unit (step 114). The celebration message may also notify the player about the exciting game features and awards of the new game. In some embodiments, the celebration message can also show advertisements for casino shows, restaurants, or for “outside products,” such as various types of merchandise, and so on.

Since several games are played on the same gaming machine in the various embodiments described herein, the gaming machine must have a hard drive that has the memory and capacity to store several games, or alternatively be connected to a game server having these features. The changing from one phase to the next causes the gaming machine to display a completely different game on the primary video screen. As was described above, most conventional gaming machines have two video screens; one for the primary game and one in the topbox just above the primary video screen. The video screen in the topbox is typically used for advertising the game theme, showing the paytable, and sometimes for showing bonus games. When the player transitions from a current phase to a new phase, one or both video screens changes to display the new game theme. The new game theme typically has different animations and graphics, different sounds, different game features, and a different paytable. The new game will typically be the same denomination, same number of spinning reels and same number of paylines as the game played in the previous phase (although it is certainly not necessary). Having a similar game may increase the chance of the player staying at the gaming machine, as he selected this particular type of game when he first decided to play the gaming machine.

If it is determined in step 112 that the player has reached the last phase, the player can play a bonus game (step 118). As an example, after completing the last phase, a message may pop up on the video screen and say “Thanks for playing—the next ten games are FREE”. The reels will spin when the player pushes the buttons, just like in conventional games, but the player is not charged for the bonus game. Another example of a bonus game can be 10 boxes, from which the player must pick one. Behind each box is hidden a number of credits that the player wins, which can be used in future games, if any. The bonus game can be much more elaborate, such as a fortune wheel on the slot cabinet or a video wheel on screen that spins and stops on prizes. Bonus games and/or other incentives can be implemented, depending on the various embodiments, as part of the individual games or as separate entities that can be selectively loaded by the game software.

Of course, in some embodiments, various bonus games can occur in between any two phases, that is, they do not have to occur only after the last phase has been completed. In some embodiments, additional bonuses (i.e., credits), rather than bonus games, can be awarded to the player. These additional bonuses should not be confused with bonuses or bonus games that may exist within each phase. Any of these additional bonuses that are awarded to the player are not awarded for accomplishing anything specific within the game, but the additional bonuses are instead based on predetermined criteria set within the game software, which criteria are unknown to the player. The percentage paid out to the player as an additional bonus or in a bonus game that takes place between phases is figured into the overall hold percentage of the game that is played after the bonus, except for the bonus game that is given after the final phase. The payout percentage for that final bonus game is figured into the previous game. In some embodiments, a percentage of the credits played in each phase can be allotted to pay for the bonuses that fall between the phases.

Irrespective of what phase the player is at, the process then allows the player to decide whether or not to continue playing (step 116). If the player does not want to continue playing, the process ends. If the player decides to continue playing in step 116, it is determined whether the player played a bonus game or cashed out (step 120). If the player played the bonus game, that is, the player had reached the last phase, or if the player cashed out (as opposed to keeping his accumulated credits for continued playing), the phase is reset to phase one (step 122) and the player wagers on the phase one game (step 102), as described above. If it is determined that the player did not play a bonus game or cashed out, then the player proceeds to play the new game (step 102). As long as the player keeps playing at the game he will sooner or later move to the next phase. The number of phases can vary between versions. There may be a designated area or window on either the primary screen or the topbox video screen or both that is used for keeping the player informed about what phase he is at. In some embodiments, if the player has not reached the final phase and stops playing, say, at phase number 5 out of 10, a ticket printer on the gaming device can print a ticket that the player can later insert into the same machine or into a similar machine to resume the phases game at the point where it was stopped.

Of course, there can be many variations to the various features described above. For example, certain embodiments have progressive jackpot amounts in each phase, that is, the jackpots get larger as the player moves from one phase to the next. For example, in the first phase the progressive jackpot amount can start at $1,000, but in the last phase, the progressive jackpot can start at $100,000. Thus, each phase can have its own progressive jackpot, which can only be won in that particular phase. It should be noted that even though the prizes, game features, certain payouts, etc., can get larger from one phase to the next, each phase is unrelated to the previous phase in that nothing achieved in the previous phase carries over to the next phase. The paytables in the different phases can have awards that are the same, larger, or smaller.

The time it takes to move between phases can vary. For example, in some embodiments, the game software can allow the player can move through the first few phases relatively quickly, to maintain the player's interest and excitement, and then spend more time at the middle and later phases.

In order to further increase the understanding of the various embodiments, a few exemplary schematic screenshots that a player may see on the video screens of the gaming machine will now be described with respect to FIGS. 2-10. Of course, as the skilled reader realizes, these are just examples that can be varied in many ways depending on the game and that can be made significantly more or less elaborate.

FIG. 2 shows a phase one game on the primary video display (202). At the top of the display (202), there is a box indicating that phase one is being played. The topbox (204) shows the theme of the game and the top prize that can be won in phase one.

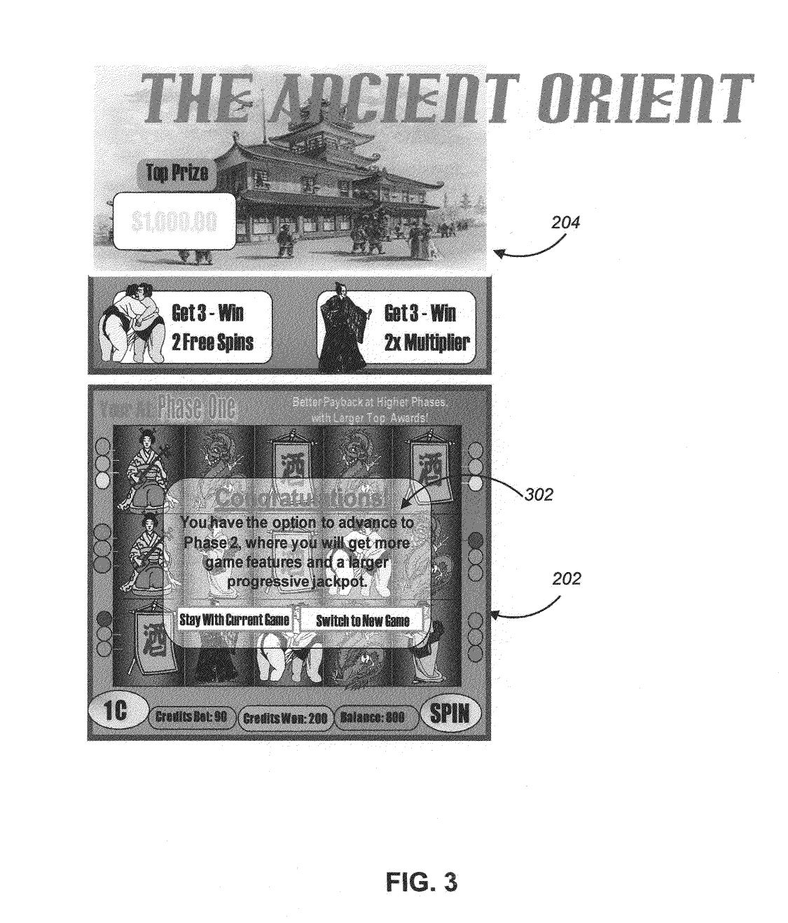

FIG. 3 shows how a message (302) is displayed on the primary video display (202) at the end of the first phase to give the player the option to move on to the next phase or to stay with the current phase.

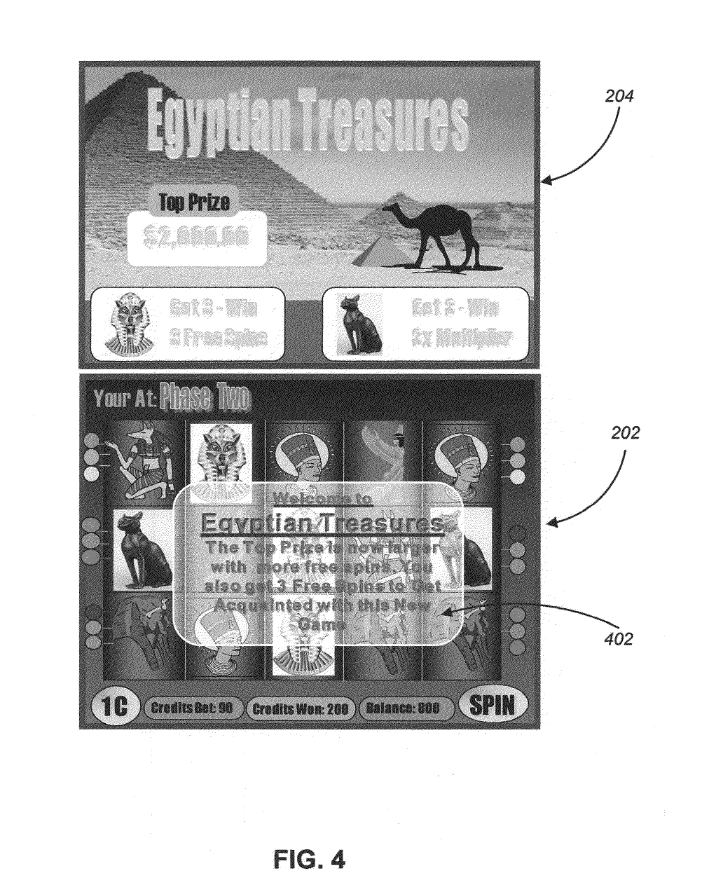

FIG. 4 shows a new game in phase two, as a result of the player agreeing to proceed to phase 2. The topbox (204) shows a different theme, “Egyptian Treasures,” a larger top prize ($2,000.00), and a set of improved game features. The primary video display (202) shows the new game and indicates that the player is now at phase two. It also shows a message (402) that informs the player about the new features of phase two and that gives the player a few free spins to get acquainted to the new game.

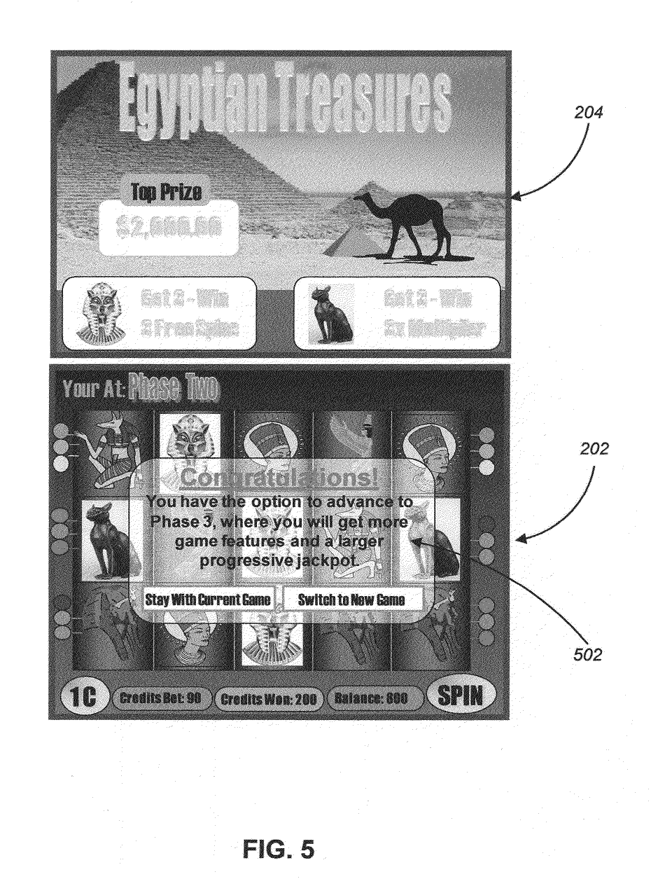

FIG. 5 shows how a message (502) is displayed on the primary video display (202) at the end of the second phase to give the player the option to move on to the third phase or to stay with the current phase.

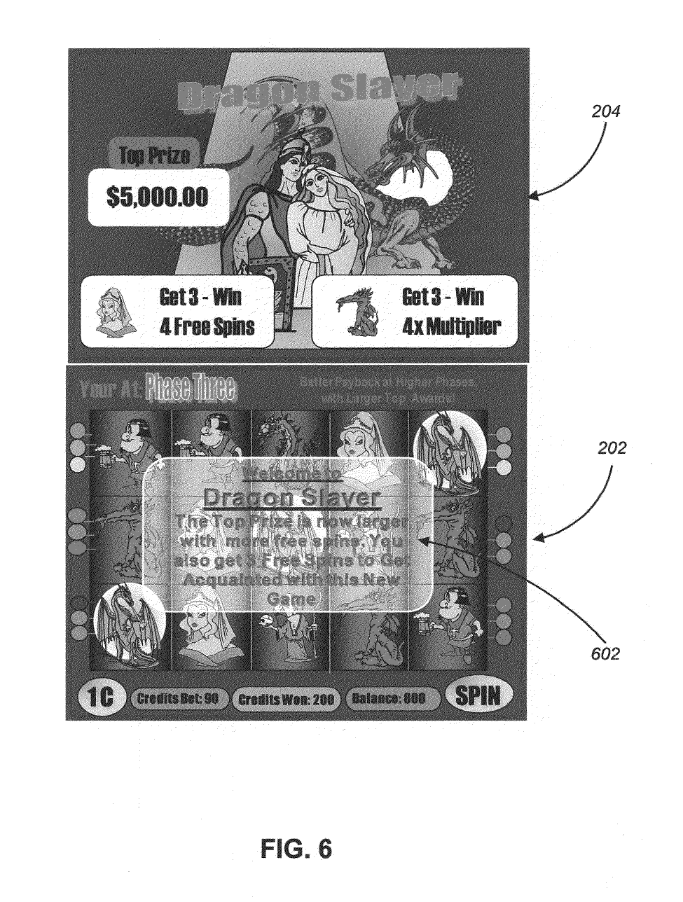

FIG. 6 shows a new game in phase three, as a result of the player agreeing to proceed to phase three. The topbox (204) shows a different theme, “Dragon Slayer,” a larger top prize ($5,000.00), and a set of improved game features. The primary video display (202) shows the new game and indicates that the player is now at phase 3. It also shows a message (602) that informs the player about the new features of phase three and that gives the player a few free spins to get acquainted to the new game.

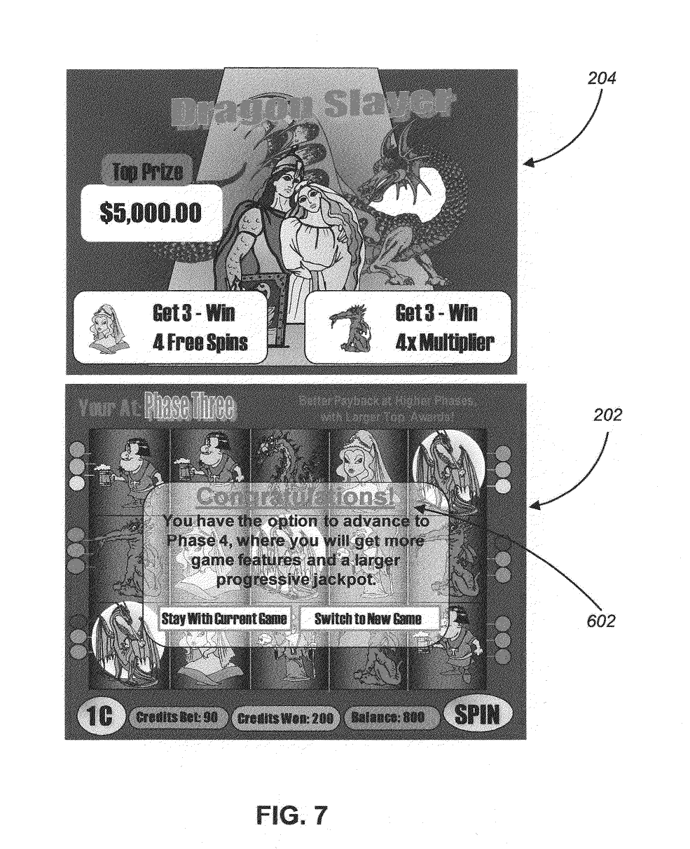

FIG. 7 shows how a message (702) is displayed on the primary video display (202) at the end of the second phase to give the player the option to move on to the fourth phase or to stay with the current phase.

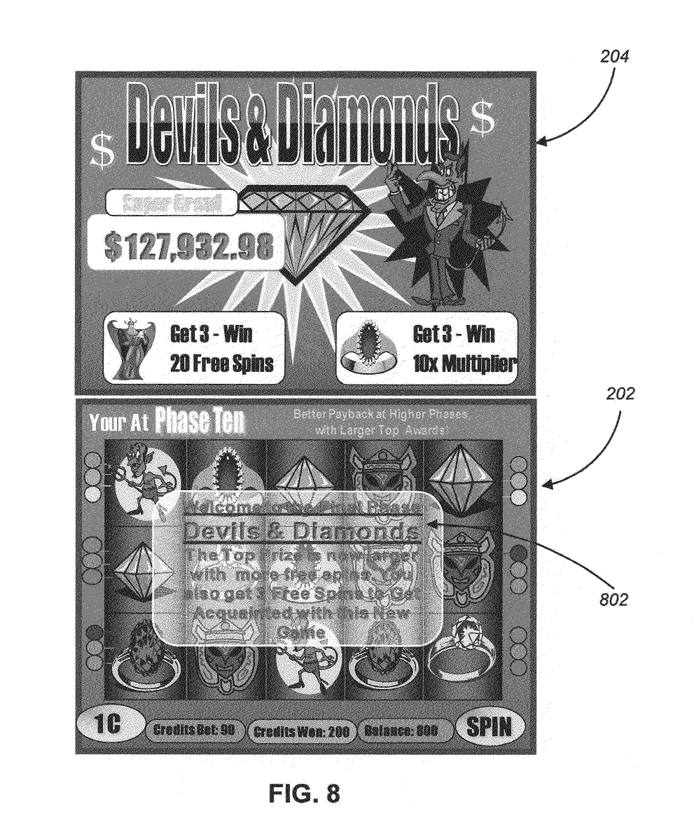

FIG. 8 shows a new game in the last phase, in this case phase 10. The topbox (204) shows a different theme, “Devils & Diamonds,” a significantly larger top prize ($127,932.98), and a set of improved game features. The primary video display (202) shows the new game and indicates that the player is now at the final phase. It also shows a message (802) that informs the player about the new features of the final phase and that gives the player a few free spins to get acquainted to the new game.

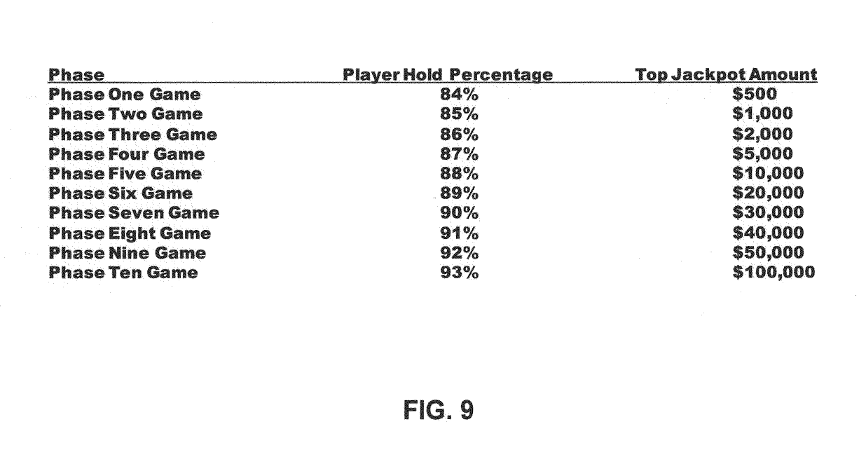

FIG. 9 is a table that shows an exemplary hold percentage and a top jackpot amount for each phase, in accordance with one embodiment. For example, the hold percentage may start at 84% for phase one and then increase by 1% through phase 10. The hold percentage can be used to build the top jackpot award for the next phase. As can be seen in the table, the top jackpot amount increases in a non-linear fashion for each phase, starting at $500 for phase 1 and ending with $100,000 for phase 10.

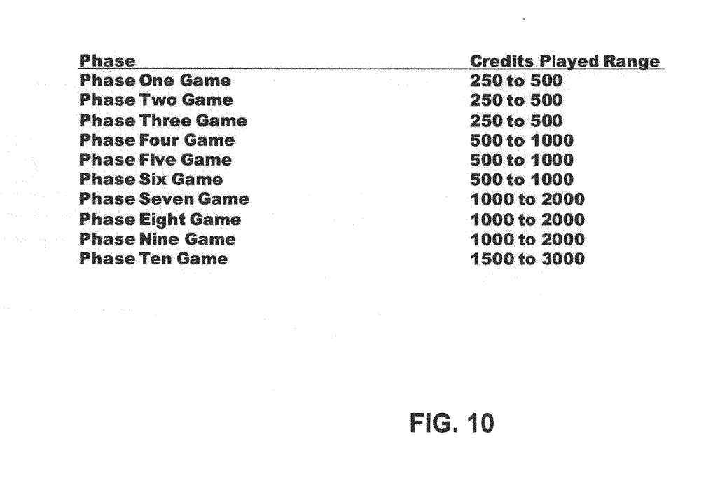

FIG. 10 is a table that shows an example of ranges of credit played before a player can move to a next phase, in accordance with one embodiment. As can be seen in the table, the credits played range for the first three phases is 250-500, for phases 4-6 the credits played range is 500-1000, for phases 7-9 the credits played range is 1000-2000, and for phase 10 the credits played range is 1500-3000. A RNG can be used to pick a number within the respective ranges, as described above. Since the lower phases require smaller numbers of credits, these phases are on average quicker to play than the larger phases which require larger numbers of credits. Of course, there are many ways in which the advancement of a player from one phase to the next can vary. For example, the strategy could change based on changing player habits. Generally, the goal is to advance the player quickly during the beginning phases to show the player the features and advantages of the phases game, then keep the player for a longer time in the middle phases by providing games that pay well for the player and the casino, and finally advance the player more rapidly through the later phases to get the player to the final phase with the best potential for winning larger sums of money, and also the highest hold percentage for the casino.

### Alternative Embodiments

As the skilled person realizes, various embodiments can be adapted to use the concept of phases in other types of games and in other contexts. A non-exclusive list of such examples is presented below.

The techniques described above can be used on other casino games, such as keno, blackjack, video poker, just to mention a few. For example, the player can be playing a “Jacks or Better” poker game on a video poker machine and after a while, the game can change to a “Deuces Wild” video poker game.

The phases concept can be used in games played on multi-game slot machines, or on slot machines having a hard drive capable of holding several games, on Internet Gambling websites, on Server-Based Gaming Systems, in home video games, on hand held devices, or on multi-player electronic table games, just to mention a few alternatives.

In some embodiments players can be informed when they are getting close to advancing to the next phase. For example, there may be a graph or some other kind of graphic that shows his progress towards the next phase. The graph or graphic may be color coded. The player can be shown the number of credits needed to reach the next phase or some form of countdown clock or other method can show the player know how close he is to the next phase.

In some embodiments, the player has to get a particular reel symbol or collect particular symbols within the game to advance to the next phase. In some embodiments, the player can advance to the next phase as soon as he has a certain number of games in which he did not win any credits, or maybe if the player has not won a certain number of credits within a certain number of games or the player loses a certain number of games in a row. The player can win a prize if he moves through all the phases in the shortest period of time, as compared to other players on the same system.

Some embodiments can be used on “community type games” were multiple players compete to get to the next phase, that is, where the first player to reach the next phase will win a bonus for that phase. Alternatively, the first player to finish all the phases will win a large prize or some other kind of bonus. In some embodiments, the techniques can be used in casino-wide promotions, for example, where all players who finish all the phases will be entered into a drawing for a large prize, such as a new car, $10,000 or $100,000, or some other major prize. There may also be linked jackpots across several gaming machines located in the same casino or through multiple casinos.

The prizes offered at each phase within the game are typically only available in that phase. Some embodiments, however, can have prizes that move along to each phase as the player moves to the different phase. For example, the same large progressive jackpot can be available at each phase.

In some server-based system embodiments, after the player has been informed that he is moving to a new phase, the player has the option to select from a group of games which game will be his next game. That is, the player may have choice of games to select from for each phase, depending on his preference. The selection of games presented to the player can be varied based on, for example, that certain games are more popular among men, others are more popular among women, yet others are more popular among young people, while others are more popular among older people, and so on.

In some embodiments, the player can win a “Mystery Prize.” The mystery prizes can be fixed or progressive. One way to trigger the mystery prize can be for the game software to first decide whether the player will win a mystery prize in this phase, and then decide what specific credit played number will trigger the mystery award. If the player hits that number within that particular phase, the player will win the mystery award.

Other game measurements can be used by the game software to determine when the player should move from one phase to the next. For example, if it is detected that the player plays a certain number of games without winning any credits, this can trigger the player to move to a new phase. In other embodiments, a certain number of credits won within a certain number of games can cause the player to move to a new phase.

In some embodiments, the primary game does not change to a completely new game when going from one phase to the next, but the current game is sufficiently changed to appear different to the player. For example, this can be done by adding a few different symbols, or change the name theme slightly (for example, by taking an original name like “Patriot Pennies” and changing it to “Patriot Pennies II”), by changing background colors, changing game sounds, providing higher frequency bonuses, or by simply increasing the payouts on the paytable or adding more lines on the game without the player paying for them. Many different steps can be taken, but the key is that the player is notified that he has been authorized for the next phase.

The marketing of the different phases can also vary. A sign can be put over gaming machines having the phases feature to advertise it. The sign may have a large LCD or plasma display in the sign announcing when the player has reached certain phases or has completed all the phases. The second LCD screen can be used to provide information to the player about moving to new phases and why that would be beneficial for the player. In some embodiments, when a player moves to the next phase, the game can highlight that event with various sounds and animations. The next phase can be sponsored by a restaurant or shop at the casino and special prizes provided by the sponsor can be won by the player during that phase. A message or advertisement can pop up announcing to the player he has advanced to the new level and optionally an advertisement by the sponsor can be shown.

The gaming machines can be linked back to a central server system so that the phases game can be played by any video gaming machine on the casino floor. The casino personnel can also send the games down to specific gaming machines. In some embodiments, the player may be able to select which games he wants downloaded to his gaming machine with the phases feature.

### Hardware and Software Configurations

### Types of Gaming Machines

As was described above, the various embodiments can be used not only on gaming machines, but also on various types of other gaming devices, such as a general purpose computer (e.g., a desk top computer, lap top computer, tablet computer, server, work station, main frame, personal digital assistant (PDA), cellular phone, and so on. Further, some units may be incorporated into other devices such as a cable or satellite set-top box, a video game system (Playstation™, XbOX™, Game Cube™) or from hand held devices (e.g. a Game Boy™)

### Wager Data Devices

One example of a gaming machine includes a housing or cabinet and one or more wager data devices, which can include a coin slot acceptor, a paper currency acceptor, a ticket reader/printer and a card reader and/or writer which can be used to input a wager to the gaming machine. As used herein, the term “wager” may encompass gaming tokens, coins, paper currency, ticket vouchers, credit or debit cards, and any other object representative of value.

### Ticket Vouchers

If provided on the gaming machine, a ticket reader/printer can be used to read and/or print or otherwise encode ticket vouchers. The ticket vouchers can be composed of paper or another printable or encodable material and can have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers can be used, such as bonus ticket vouchers, cash-redemption ticket vouchers, restaurant ticket vouchers, show ticket vouchers, and so on.

### Audio

The gaming machine can optionally include one or more audio speakers, a coin payout tray, an input panel and one or more display units for displaying display data in the primary display area and secondary display area relating to the base game and secondary game provided by the gaming machine. The audio speakers may generate audio representing sounds such as the noise of spinning gaming machine reels, a dealer's voice, music, announcements or any other audio related to a casino game.

### Control Panel

The input control panel can have several push buttons or touch-sensitive areas that may be pressed by the player to select games, make wagers, make gaming decisions, and so on. The display unit can be a two dimensional display unit such as a color video display unit such as a holographic display, a stereoscopic display, a three dimensional display volume, and so on. It should be understood that different buttons can be used in the control panel, and that the particular buttons used can depend on the game or games that can be played on the gaming machine. The control panel can be separate from the display unit(s) displaying the primary display area and the secondary display area, or it can be generated by the display unit. In that case, each of the buttons of the control panel can be a colored area generated by the display unit, and some type of mechanism may be associated with the display unit to detect when each of the buttons was touched, such as touch sensitive screen.

### Controller

A controller coordinates the actions and data transfer between the various components of the gaming machine. In some embodiments, the controller includes a processor and a memory storing instructions for how the phases game is to be carried out in the various game embodiments described above. In other embodiments, the game instructions are not persistently stored in the memory, but instead the controller can download the instructions from a remote source, as will be described in further detail below. In some embodiments, the controller can also interface with controllers in other gaming machines to enable community gaming scenarios as well as wide-area progressive jackpot systems scenarios, as was described above.

### Networked Embodiments

In some networked embodiments, a game server can be provided, which includes a computer, such as a desktop computer, a laptop computer, a work station, a server, a mainframe, and so on. The game server can include a controller that can include a program memory, a microcontroller or microprocessor, a random-access memory (RAM), and an input/output (I/O) circuit, all of which may be interconnected via an address/data bus. A display and one or more input devices can be operatively coupled to the I/O circuit, each of those components being so coupled by either a unidirectional or bidirectional, single-line or multiple-line data link, which may depend on the design of the component that is used. The gaming machine can transmit to the server an indication that the player submitted the requested payment to the gaming machine by, for example, inserting currency, deducting value from a smart card, authorizing a charge to a credit card or debit card, authorizing a deduction form an account, and so on.

The processor optionally can be coupled to a computer or telecommunications network, for example, the Internet, or an intranet, using a network connection, through which the processor can receive information from the network, or can output information to the network in the course of performing the above-described method steps. Such information, which is often represented as a sequence of instructions to be executed using the processor, may be received from and outputted to the network, for example, in the form of a computer data signal embodied in a carrier wave.

### Software Downloading

Appropriate software can be loaded to the gaming machine. The software can be loaded through a network connection, a floppy disk, a CD-ROM, a DVD, a PC card, smart card, and so on. The software can be loaded through a portable memory device, a multi-media card memory device, a smart media memory device, memory stick memory device, or similar devices.

### Game Software

The software can include one or more of an executable file, a configuration file, a data file, a pay table, and so on. The software can also include several seeds for a random number generator. The seeds can be, for example, randomly or pseudo-random generated. The software can be used to configure the controller. The software can be different for different types of gaming machines. Once the software has been loaded onto a gaming machine, the player can use the gaming machine to play the game corresponding to the loaded software.

It should be noted that while casinos have gaming devices with multi-game capabilities, the game software used for the phases game described herein is different in that it does not merely provide the option of having multiple games on one gaming device. In contrast, the phases game software further ensures as much as possible that the player gets a game he likes and that the longer the player stays at the gaming device, the better the games in the various phases get.

### Computer Operations

It should be noted that the above embodiments employ various computer-implemented operations involving data stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

### Game Program

The various embodiments can be implemented in digital electronic circuitry, or in computer hardware, firmware, software, or in combinations of them. Apparatus can be implemented in a computer program product tangibly embodied in a machine-readable storage device for execution by a programmable processor; and method steps can be performed by a programmable processor executing a program of instructions to perform functions by operating on input data and generating output. The various embodiments can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

### Slot Machine Display

To provide for interaction with a user, a computer system can have a display device such as a monitor or LCD screen for displaying information to the user. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users. A video controller can manage what is displayed on the top box display. This same controller, or a separate progressive controller, can be used for the progressive or mystery jackpot amounts.

### Server Based Versions

Various embodiments can be a stand-alone product which means all hardware and software needed to run any game is located within the slot cabinet and requires no connection to an outside slot network or system for the player to run the game. In other embodiments, some or all the gaming machines within a casino may be connected to a casino wide slot network. A central system will be located in a protected room and will communicate to all gaming machines located on the casino floor through a slot network. Currently player club cards and accounting information already connects all the gaming machines to a central system. Several different methods may be used in the future to configure the gaming machines on the floor. One method is for games to be down loaded from the central system through the network to each of the slot cabinets. The games are then stored at the gaming machine game. The central system operator can change out any of the games at each of the gaming machines. Another method is for the games to reside on the central system servers. The players through an interface on the gaming machine will play the games but the games are not stored at the gaming machine they are being played at the central system, much like games are played on the internet. In either method a certain game or group of games is authorized to be played at each of the gaming machines. The player is in control and can pick any game that the central system has to offer through a menu interface and the games he chooses will be either downloaded or server-based. Accordingly, other embodiments are within the scope of the following claims.

1. A computer-implemented method for playing a video casino game on a gaming device, the method comprising:
providing a gaming device operable to display a video casino game to a player;
receiving a wager from the player, the wager indicating an initial number of credits to be played in the video casino game;
tracking a total number of credits played by the player on the gaming device;
selecting, by a random number generator, a number within an established range of numbers;
in response to detecting that the total number of credits played by the player is equal to or exceeds the selected number, presenting a new video casino game to the player; and
repeating the tracking, selecting and presenting steps until an ending criterion has been reached, the ending criterion including one of: the player ceasing playing the video casino game, and the player having played a predetermined number of video casino games.

2. The method of claim 1, further comprising:
downloading the new game to the gaming device from a central game server that contains a library of games.

3. The method of claim 1, wherein the new game has one or more of: a different theme, different reel symbols, different animations and graphics, different game sounds, and different game features, compared to the game being played.

4. The method of claim 1, further comprising:
starting over with the first game after the player has played the predetermined number of video casino games.

5. The method of claim 1, further comprising:
presenting a bonus game to the player, in which bonus game no wager is required and in which bonus game the player is guaranteed to win bonus credits.

6. The method of claim 1, wherein:
each new game has a higher hold percentage; and
the top award for the new game is larger than the top award for the current game.

7. The method of claim 1, wherein the video casino game is one of: a video spinning reel game, a video poker game, a video keno game, and a video blackjack game.

8. The method of claim 1, wherein the new game is of a similar type to the current game.

9. The method of claim 1, wherein the gaming device is one of: a gaming device operable to play the game over the Internet, a gaming device operable to play the game through a home video game network, and a handheld device.

10. The method of claim 1, further comprising:
displaying an advertisement to the player prior to allowing the player to play the new game.

11. The method of claim 1, wherein each game has a progressive jackpot that is unique to the particular game being played.

12. The method of claim 1, further comprising:
presenting the player with an option to continue playing the current game or to proceed to the new game.

13. The method of claim 1, further comprising:
presenting the player with a menu of games from which the player can make a selection of a game to be played as the new game.

14. The method of claim 1, further comprising:
analyzing the player's playing habits and game results; and
in response to detecting a significant change in playing habits or game results, presenting the new game to the player.

15. The method of claim 1, further comprising:
issuing a ticket to the player, which ticket can be redeemed at a later time by the same or a similar gaming device to resume the video casino game at the point where the ticket was issued.

16. A video gaming device, comprising:
a housing;
a display unit operable to display a video casino game;
a wager input device operable to receive a wager from a player of the video casino game;
an input control panel operable to receive input from the player for playing the video casino game; and
a control unit operable to:
convert a received wager into an initial number of credits to be played in the video casino game;
track a total number of credits played by the player on the gaming device;
select, by a random number generator, a number within an established range of numbers;
in response to detecting that the total number of credits played by the player is equal to or exceeds the selected number, cause the display unit to display a new video casino game to the player; and
repeat the tracking, selecting and presenting steps until an ending criterion has been reached, the ending criterion including one of: the player ceasing playing the video casino game, and the player having played a predetermined number of video casino games.

17. The gaming device of claim 16, wherein the gaming device is a video spinning reel machine and the input control panel is one of: a touch sensitive area on the display unit, and one or more physical buttons on a panel of the video spinning reel machine.

18. The gaming device of claim 16, wherein the control unit is further operable to:
download the new game to the gaming device from a central game server that contains a library of games.

19. The gaming device of claim 16, wherein the control unit is further operable to:
present a bonus game on the display unit, in which bonus game no wager is required and in which bonus game the player is guaranteed to win bonus credits.

20. The gaming device of claim 16, wherein the control unit is further operable to:
cause the display unit to present the player with a menu of games from which the player can make a selection of a game to be played as the new game.
